(19) United States
(12) Patent Application Publication
(10) Pub. No.: US 2025/0082123 A1
(43) Pub. Date: Mar. 13, 2025

(54) FINIAL ATTACHMENT MECHANISM FOR CURTAIN ROD APPARATUS AND RELATED METHODS

(71) Applicant: Lumino, Inc., Madison, WI (US)

(72) Inventors: Michael Kollman, Fitchburg, WI (US); Doug Powell, Fitchburg, WI (US)

(21) Appl. No.: 18/462,478

(22) Filed: Sep. 7, 2023

(51) Int. Cl. A47H 1/022; F16B 7/04

(52) U.S. Cl. CPC A47H 1/022; F16B 7/0406; A47H 2001/006

(57) ABSTRACT

A curtain rod apparatus includes a curtain rod having opposite ends. Each end can include a finial attachment mechanism. Each finial attachment mechanism can include at least one magnetic elopement of a finial attachment assembly positionable within the curtain rod that can be configured to facilitate attachment of a finial to the end of the curtain rod. In some embodiments, the assembly for each finial attachment mechanism can be configured so that no tools are needed beyond use of a user's hands to attach finials to the ends of the curtain rod.

### FIELD OF INVENTION

The present innovation relates to curtains, curtain rods, finial attachment mechanisms for curtain rods, and methods of making and using such devices.

### BACKGROUND OF THE INVENTION

Curtains can be used to cover a window. Often, such curtains are positioned on a curtain rod mounted above a window opening. The curtain rod can be mounted via at least one bracket assembly. The curtain rod can have finials attached to the ends of the rod. Examples of curtains and curtain rods can be appreciated from U.S. Patent Application Publication Nos. 2018/0098656 and 2016/0374498 as well as U.S. Pat. Nos. 4,140,294 and 7,322,552 and U.S. Design Patent Nos. D630,934, D623,458, D604,151, and D592,944.

### SUMMARY OF THE INVENTION

We have determined that a curtain rods often limit aesthetic options for curtains (e.g. drapes, curtains, etc.). For example, curtain rods can be mounted to support curtain or drapery and have free ends of affixed finials. These finials can be difficult to attach by consumers. Further, they are often not designed for being easily replaced. We determined that this can limit the ability of a person to adjust their home décor or business décor concerning their curtains without using new curtain rod hardware, tools, or relatively extensive work. Embodiments of our curtain rod apparatus, finial attachment mechanism, and related methods can avoid such shortcomings by permitting users to easily attach, remove, and/or replace finials for their curtain rods. This can permit home décor or business décor to be changed quickly and easily to account for the seasons, changes in personal preferences, or other reasons. Some embodiments can be provided so a user can removably attach finials to a curtain rod and/or easily remove and replace finials without use of any tools.

A curtain rod apparatus is provided that can include a curtain rod having a first end and a second end and a plurality of finial attachment mechanisms including a first finial attachment mechanism and a second finial attachment mechanism. The first finial attachment mechanism can be positionable in the first end of the curtain rod and the second finial attachment mechanism can be positionable in the second end of the curtain rod. Each of the finial attachment mechanisms can include a receptacle element positionable in the curtain rod and a magnetic member positionable in or adjacent the receptacle element.

The receptacle element can be configured to retain a fastener, projection, or magnetic member in some configurations. For example, the receptacle element can be positionable within the curtain rod for receipt of projection extending from a finial or a fastener extending from a finial. In some configurations, the receptacle element can also be configured to receive or retain the magnetic member. The receptacle element can be non-magnetic in some embodiments. In other embodiments, the receptacle element can be comprised of a magnetic or magnetic material.

In some embodiments, each of the finial attachment mechanisms can also include a push plug element positionable within the receptacle element adjacent to the magnetic member. Each of the finial attachment mechanisms can also include a magnetic element positionable between the magnetic member and the push plug element. In some embodiments, the magnetic element can include a pin comprised of a ferromagnetic material and/or comprises a magnet.

The curtain rod apparatus can also include a first finial removably attached to the first end of the curtain rod via the first finial attachment mechanism and a second finial removably attached to the second end of the curtain rod via the second finial attachment mechanism. The first finial can be removably attached to the first end of the curtain rod via magnetic attraction with the magnetic member of the first finial attachment mechanism without use of any mechanical tool and the second finial is removably attached to the second end of the curtain rod via magnetic attraction with the magnetic member of the second finial attachment mechanism without use of any mechanical tool. in some embodiments

The curtain rod can be an adjustable length curtain rod or a fixed length curtain rod. The curtain rod can be a tubular curtain rod or be an annular curtain rod (e.g. polygonal shaped curtain rod with an inner channel defined therein) . . . . The curtain rod can be configured to support curtain material hangable from the curtain rod.

The curtain rod apparatus can also include one or more mounting brackets configured to be mounted to a wall adjacent to a window opening to hold the curtain rod above the window opening or adjacent the window opening. Some embodiments may utilize two mounting brackets or more than two mounting brackets, for example.

In some embodiments, a first finial can be removably attached to the first end of the curtain rod via the first finial attachment mechanism and the first finial can have a first collar defined in a proximal end of the first finial. The first collar can have a gap that is sized to receive a portion of the first end of the curtain rod therein. A second finial can also be removably attached to the second end of the curtain rod via the second finial attachment mechanism. The second finial can have a second collar defined in a proximal end of the second finial. The second collar can have a gap that is sized to receive a portion of the second end of the curtain rod therein.

A finial attachment mechanism for removably attaching a finial to an end of a curtain rod is also provided. Embodiments of the final attachment mechanism can include a receptacle element positionable in the end of the curtain rod and a magnetic member positionable in or adjacent the receptacle element for magnetic attachment with the finial for removably attaching the finial to the end of the curtain rod.

In some embodiments, the receptacle element can have at least one slit in communication with a channel. The magnetic member can be positioned within the channel of the receptacle element. The receptacle element can have an inner end and an outer end and each of the at least one slit can extend from the inner end to an intermediate portion of the receptacle element that is spaced apart from the outer end.

Embodiments of the finial attachment mechanism can also include a push plug element positionable within the receptacle element adjacent to the magnetic member. A magnetic element can also be positionable between the magnetic member and the push plug element. In some configurations, the magnetic element can include a pin comprised of a ferromagnetic material and the magnetic member can be or include a magnet.

Embodiments of the finial attachment mechanism can be configured so that the removable attachment of the finial to the end of the curtain rod via the magnetic member is without use of a mechanical tool.

In some embodiments, the finial attachment mechanism can be configured so that the magnetic member has a hole that is alignable with a hole of the receptacle element. The hole of the magnetic member and the hole of the receptacle element can be sized to receive a fastener or projection extending from the finial. The holes and projection can help centrally locate the finial for attachment of the finial. The proximal end of the finial can include a collar having a gap defined therein that can receive an annular edge portion of the curtain rod end to which the finial is to be attached to help secure the finial to the end of the curtain rod for a secure releasable attachment to the end of the curtain rod.

A process for finial replacement is also provided. The process can include providing a finial replacement kit comprising replacement finials for attachment to a curtain rod. The replacement finials can include a first replacement finial and a second replacement finial. The process can also include removing a first finial attached to a first end of the curtain rod without use of a mechanical tool via a first finial attachment mechanism of the first end of the curtain rod and removing a second finial attached to a second end of the curtain rod without use of a mechanical tool via a second finial attachment mechanism of the second end of the curtain rod. The process can also include attaching the first replacement finial to the first end of the curtain rod without use of a mechanical tool via a magnetic attraction between a magnetic member of the first finial attachment mechanism and the first replacement finial and attaching the second replacement finial to the first end of the curtain rod without use of a mechanical tool via a magnetic attraction between a magnetic member of the second finial attachment mechanism and the second replacement finial.

Embodiments of the process can utilize embodiments of the final attachment mechanism discussed above or features of the finial attachment mechanisms included in exemplary embodiments of the finial attachment mechanism discussed herein. It should also be appreciated that different embodiments of the curtain rod apparatus or finial attachment mechanism can include one or more features of any of the exemplary embodiments of the finial attachment mechanisms discussed herein. Embodiments of our processes can also include one or more features of any of the exemplary embodiments of our process discussed herein.

Other details, objects, and advantages of the curtain rod apparatus, finial attachment mechanism, and methods of making and using the same will become apparent as the following description of certain exemplary embodiments thereof proceeds.

### BRIEF DESCRIPTION OF THE DRAWINGS

Exemplary embodiments of the curtain rod apparatus, finial attachment mechanism, and methods of making and using the same are shown in the accompanying drawings. It should be understood that like reference numbers used in the drawings may identify like components.

FIG. 1 is schematic view of a first exemplary embodiment of a curtain rod apparatus 1 with an intermediate section of the curtain rod 2 shown in broken line to indicate indeterminate length. The length of the curtain rod 2 and the shape of the curtain rod can be any of a number of suitable dimensions to meet a particular set of design criteria (e.g. size of window opening to be covered with curtains, etc.).

FIG. 2 is an exploded view of a first exemplary embodiment of a finial attachment mechanism 10 that can be include in the first exemplary embodiment of curtain rod apparatus 1.

FIG. 3 is a perspective view of a push plug element 8 of the first exemplary embodiment of the finial attachment mechanism 10.

FIG. 4 is a perspective view of a curtain rod receptacle element 5 of the first exemplary embodiment of the finial attachment mechanism 10.

FIG. 5 is a cross-sectional view of the curtain rod receptacle element 5 of the first exemplary embodiment of the finial attachment mechanism 10.

FIG. 6 is an exploded view of a second exemplary embodiment of a finial attachment mechanism 10 that can be include in the first exemplary embodiment of curtain rod apparatus 1.

FIG. 7 is an exploded view of a third exemplary embodiment of a finial attachment mechanism 10 that can be include in the first exemplary embodiment of curtain rod apparatus 1.

FIG. 8 is an exploded view of a fourth exemplary embodiment of a finial attachment mechanism 10 that can be include in the first exemplary embodiment of curtain rod apparatus 1.

FIG. 9 is a cross sectional exploded view of the fourth exemplary embodiment of a finial attachment mechanism 10 that can be include in the first exemplary embodiment of curtain rod apparatus 1.

FIG. 10 is a flow chart illustrating a first exemplary embodiment of a method for providing a curtain rod apparatus with removably attachable finials, which includes a first exemplary process RS for providing finial replacement kits and/or replacement finials.

### DETAILED DESCRIPTION OF EXEMPLARY EMBODIMENTS

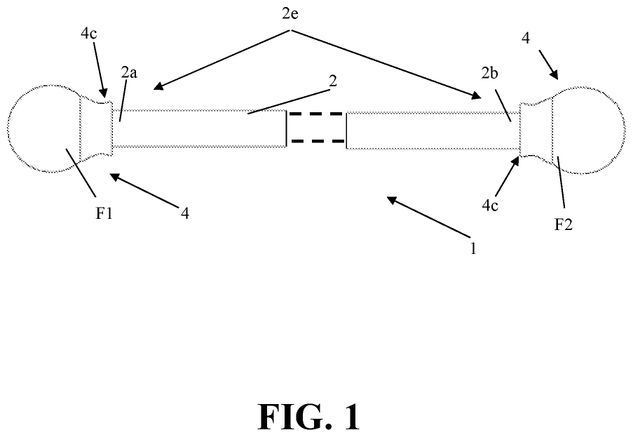

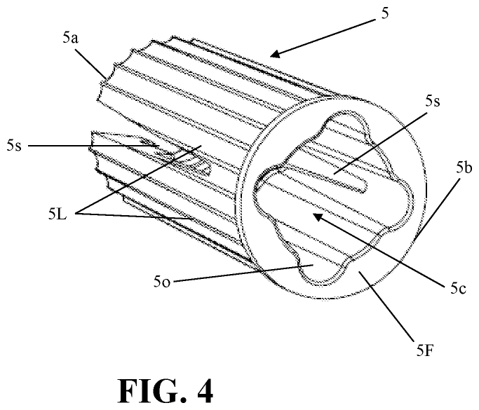

As can be appreciated from FIGS. 1-9, a curtain rod apparatus 1 can include a curtain rod 2 that can be an elongated member that is sized to be mounted adjacent to a window opening for holding curtains. Curtains can be hung from the curtain rod 2 via hooks, rings, or other curtain holders, for example. Curtain material for the curtains can include drapery, curtain material, or other type of suitable material for a desired aesthetic effect. The curtain rod 2 can be tubular (e.g. cylindrical or polygonal shaped member having an inner channel).

The curtain rod 2 can have a length that extends between opposite ends 2e of the curtain rod 2. For instance, a first end 2a can be opposite a second end 2b of the curtain rod 2 and the distance between the first and second ends 2a and 2b can define the length of the curtain rod 2. The length of the curtain rod 2 can be adjustable via moveable elements that are attached between the opposite ends 2e of the curtain rod or the curtain rod 2 can be a fixed length curtain rod 2.

For instance, in some embodiments, the curtain rod 2 can be configured to be telescoping or adjustable to provide an adjustable length curtain rod 2. For instance, the first end 2a can be a terminal part of a first portion of a first telescoping element of the curtain rod that is moveable relative to another second portion of the curtain rod 2 that includes the second end 2b. The first portion having the first end 2a can be rotated to unlock the first telescoping element (e.g. first portion with first end 2a) from the second portion for movement of that element to extend or retract it for adjusting a length of the curtain rod 2. Once in a desired length position, the first portion having the first end 2a can be rotated to lock the position of the curtain rod 2 at the new length.

In other embodiments, the curtain rod 2 can be a fixed length. For example, the curtain rod 2 can be a unitary rod of a fixed length that extends between the opposite ends 2e of the rod.

The curtain rod apparatus 1 can include finials 4 attached to the ends 2e of the curtain rod. The finials 4 can be removably attached to the ends 2e of the curtain rod 2 so that they can be replaced with other replacement finials 4, for example. A first finial F1 can be attached to the first end 2a of the curtain rod 2 and a second finial F2 can be attached to the second end 2b of the curtain rod 2. Each finial 4 can be attached to its respective end 2e of the curtain rod 2 via a respective finial attachment mechanism 10. Each finial attachment mechanism 10 can be configured so that a mechanical tool is not needed for finial attachment (e.g. only a user hands, the finial 4, and the finial attachment mechanism 10 can be utilized for attachment).

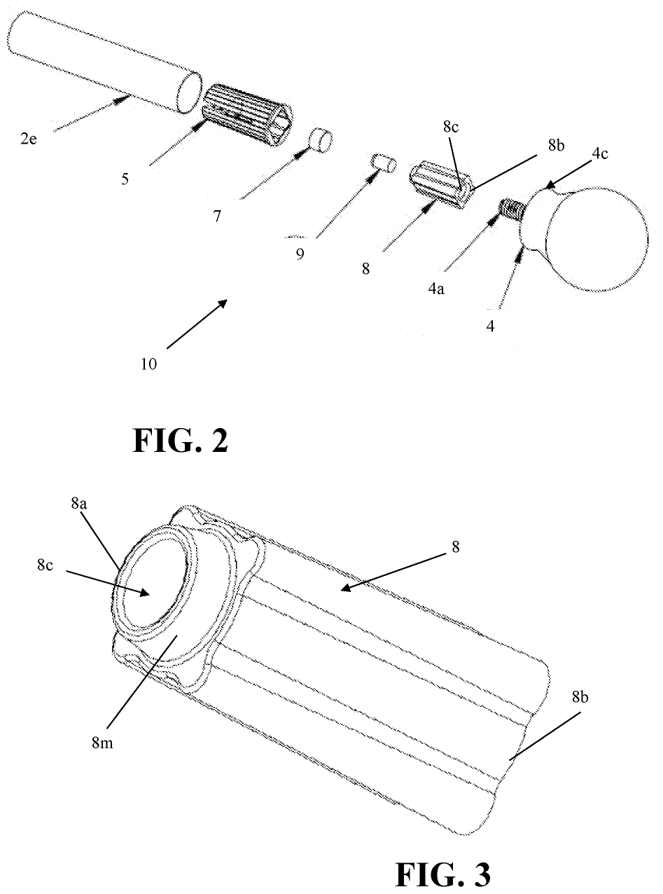

FIGS. 2, 6, and 7 illustrate examples of finial attachment mechanisms 10 that can be utilized to provide the attachment of each finial 4 to a respective end 2e of the curtain rod 2 (e.g. attachment of first finial F1 to first end 2a and attachment of second finial F2 to second end 2b). Each of these exemplary embodiments of the finial attachment mechanism 10 can be configured so that a mechanical tool is not needed for finial attachment (e.g. only a user hands, the finial 4, and the finial attachment mechanism 10 can be utilized for attachment of the finial to an end 2e of the curtain rod 2).

Referring to FIG. 2, each finial attachment mechanism 10 can include a curtain rod receptacle element 5 that is positionable within an inner channel of an end 2e of the curtain rod 2. The receptacle element 5 can include an inner end 5a and an outer end 5b that is opposite the inner end 5a. The inner end 5a can also be considered a first end and the outer end 5b can also be considered a second end. The receptacle element can have a body that extends between its first and second ends as an annular structure having an inner channel 5c. At least one slit 5s can be defined in the body of the receptacle element. Each slit 5s can be in communication with the inner channel 5c, which can extend from the inner end 5a to the outer end 5b within the interior of the body of the receptacle element 5.

In some configurations, the body of the receptacle element can include a first slit 5s defined in a first side that can extend between the inner end 5a and outer end 5b and a second slit 5s that can be defined in a second side that can extend between the inner end 5a and outer end 5b. The first and second sides can be left and right sides or top and bottom sides, for example. Each slit 5s can extend for a portion of the length of the body or for a substantial portion of the length of the body of the receptacle element (e.g. extend from the inner end 5a to an intermediate portion of the receptacle element adjacent the outer end 5b). The one or more slits 5s can define one or more legs 5L of the receptacle element 5 that can extend from the face 5F of the receptacle element 5 defined at its outer end 5b. The face 5F can include a flange or overhang portion configured to rest or contact the periphery of the curtain rod at the end 2e of the curtain rod 2.

The receptacle element 5 can be size and configured so a user can use a hand to position the receptacle element 5 within the channel of the end 2e of the curtain rod 2. One or more legs 5L of the receptacle element 5 can be positionable in contact with the inner wall of the curtain rod that defines the channel in which the receptacle element 5 is positioned to provide an interference fit with the curtain rod 2. The outer end 5b of the receptacle element can also be sized to define an outer face 5F of the receptacle element 5 that can be positioned on and in contact with the outer peripheral portion of the end 2e external to the end 2e of the curtain rod 2.

The outer end 5b can have an opening 50 defined therein to receive a push plug element 8. The opening 50 can have a shape configured to mate with the cross-sectional shape of the push plug element 8 so that the push plug element 8 can be pushed into the channel 5c of the receptacle element 5 for being retained within the channel 5c. A portion of the push plug element 8 can contact the inner portion of the receptacle element 5 that defines the channel 5c as the push plug element 8 is pushed into the channel 5c of the receptacle element 5. For example, a portion of the push plug element 8 can slide along the receptacle element within the channel 5c when being pushed into the channel 5c of the receptacle element 5.

The opening 50 can also be sized to receive a magnetic member 7 (e.g. a magnet, a member comprised of ferromagnetic material, etc.). The magnetic member can be or include a disc shaped magnet or other type of magnet having a different type of shape. The magnetic member 7 can be sized to pass through the opening 50 and be positionable within the channel 5c of the receptacle element 5 for being positioned adjacent an inner end 8a of the push plug element 8.

For example, a user can use his or her hand to place the magnetic member 7 within the channel 5c to position the magnetic member 7 within the body of the receptacle element 5 in the channel 5c. The one or more slits 5s of the receptacle element 5 can be configured to permit the body of the receptacle element 5 to flex within the channel of the end 2e of the curtain rod 2 to accommodate the magnetic member 7 within the receptacle element 5 so that the magnetic member 7 can have a tight interference fit with the inner portion of the body of the receptacle element 5 that defines the channel 5c for attachment of the magnetic member 7 to the receptacle element 5 within the channel 5c. The legs 5L of the receptacle element 5 can be configured to be resiliently biased to engage the magnetic member 7 in the channel 5c for holding the magnetic member 7 therein, for example.

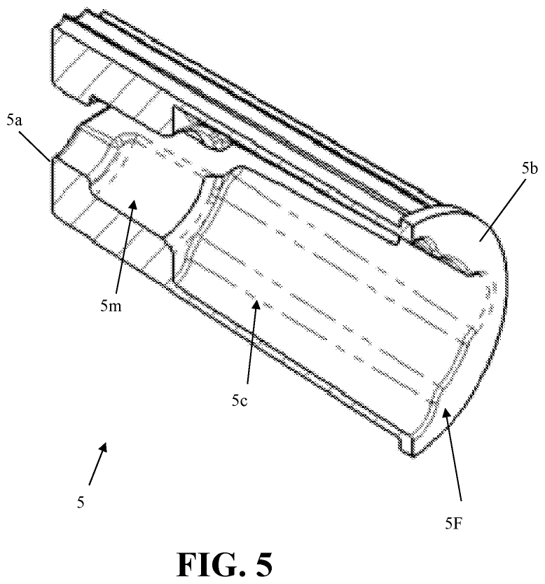

As may best be seen from FIG. 5, the receptacle element 5 can define a chamber 5m that is within the channel 5c for receipt and holding of the magnetic member 7. The chamber 5m can be a defined recess within an inner portion of the receptacle element that defines the channel 5c, for example. The chamber 5m can include or be at least one recess within the channel 5c. The chamber 5m can be defined and shaped to mate with the shape of the magnetic member 7 for retaining the magnetic member 7 within the chamber 5m.

The positioning of the magnetic member 7 within the receptacle element 5 can occur before the receptacle element 5 is positioned in the end 2e of the curtain rod 2 or can occur after the receptacle element 5 is positioned in the end 2e of the curtain rod 2.

The push plug element 8 can be insertable into the channel 5c of the receptacle element 5 after the magnetic member 7 is positioned in the receptacle element 5. This insertion can occur before the receptacle element 5 is within the end 2e of the curtain rod 2 or after the receptacle element 5 and magnetic member 7 are positioned in the end 2e of the curtain rod 2. The push plug element 8 can be configured so a user can use his or her hand to position the push plug element 8 in alignment with the opening 50 of the face 5F of the receptacle element 5 and push the push plug element 8 into the channel 5c until the push plug element 8 is within the channel 5. An outer end 8b of the push plug element 8 can be positioned at the face 5F within the opening 50 after the push plug element 8 is within the channel 5c of the receptacle element 5.

In some embodiments, the push plug element 8 can be a separate element that is attachable between the finial 4 and the receptacle element 5 via a fastener 4a of the finial 4. The fastener can be a bolt, screw, or a projection of the finial 4, for example. In other embodiments, the push plug element 8 can be a portion of the finial 4 and project from the finial for insertion into the receptacle element 5. In such a configuration, a magnetic element 9 can be included with the push plug element 8 so it projects from the inner end of the push plug element 8 that projects from the finial 4.

The push plug element 8 can have a length that extends from the outer end 8b of the body of the push plug element 8 to its inner end 8a (the outer end 8b of the push plug element 8 can be considered a second end and the inner end 8a can be considered a first end of the push plug element as well). The inner end 8a of the push plug element 8 can be positioned adjacent to the magnetic member 7 in the channel 5c and/or can be in contact with it. The push plug element 8 can also have a diameter or width that is perpendicular to its length. The push plug element 8 can include a magnetic connection element 8m defined in the push plug element adjacent its inner end 8a or at its inner end 8a. The magnetic connection element 8m can be sized and configured to receive and retain a portion of a magnetic element 9 that can extend through an aperture of the inner end 8a and into an inner channel 8c of the push plug element 8. The inner channel 8c of the push plug element 8 can extend to the outer end 8b and be positioned and configured to receive a fastener 4a that can extend from a finial 4 (e.g. bolt or screw that may extend from a bod of the finial 4) so the fastener 4a can be in contact with the magnetic element 9 and/or be magnetically attracted to a magnetic field that can be formed via the magnetic member 7 and/or the magnetic element 9.

The magnetic element 9 can be a dowel pin, pin, or other similar type element that can be comprised of a magnet, magnetic material, ferrous material or ferromagnetic material or other type of magnetic material for interacting with the magnetic member 7 (when present) for facilitating a magnetic attraction between the finial 4 (e.g. finial fastener 4a and/or other portion of finial 4). This magnetic element 9 can be positioned in the push plug element 8 via its channel 8c after the push plug element 8 is inserted into the receptacle element 5 or prior to it being inserted into the receptacle element 5. In some embodiment, the magnetic element 9 can be utilized to help provide an improved tolerance for use of the magnetic member 7 within the receptacle element 5 to account for different sized fasteners 4a that can extend from the finial 4 for insertion into the push plug element 8 via its channel 8c, for example. A shorter fastener element 4a can be accommodated by having a larger portion of the magnetic element 9 within the channel 8c for example. In contrast, a longer fastener element 4e can extend into more of the channel 8c.

In some configurations, the magnetic element 9 can be configured as a magnet or magnetic member for creating a magnetic attraction for magnetically attaching the finial 4 to the end 2e of the curtain rod 2. In some embodiments, the magnetic member 7 can also be present and also be a magnet to help provide such a magnetic attachment with the finial 4.

In other embodiments, the magnetic member 7 may not be used and instead only the magnetic element 9 may be used. In such an embodiment, the magnetic element 9 can be a magnet or include a magnet and can be considered a magnetic member.

In yet other embodiments, the magnetic element 9 can be a magnet or include a magnetic and can interact with the magnetic member 7 wherein the magnetic member 7 is comprised of a ferromagnetic material. In such an embodiment, the magnetic member 7.

It should therefore be appreciated that there are different embodiments that can utilize the magnetic element 9 in different ways to help provide a magnetic attachment with the finial 4 for removable attachment of the finial 4 to the end 2e of the curtain rod 2.

The push plug element 8 and/or magnetic element 9 can also be arranged and provided in different ways for the finial attachment mechanism 10. For example, in some embodiments, the push plug element 8 and magnetic element 9 can be provided with the receptacle element 5 and magnetic member 7 as an assembly for insertion and positioning in an end 2e of the curtain rod 2 or be provided in the end 2e of the curtain rod 2 via a manufacturer. In other arrangements, the receptacle element 5 can be included in the end 2e of the curtain rod and the magnetic element 9 and push plug element 8 can be assembled and included with the finial 4 (e.g. the push plug element 8 can be pre-attached to the finial fastener 4a or the push plug element 8 can be a portion of the finial 4 for projecting from the finial 4 for insertion into the receptacle element 5, etc.) for insertion into the receptacle element 5 for magnetic attachment of the finial 4 to the end 2e of the curtain rod 2.

In yet other embodiments, the receptacle element 5 can be included in the end 2e of the curtain rod with the magnetic member 7 positioned in the chamber 5m of the receptacle element 5. The push plug element 8 can be included with the finial 4 for insertion into the receptacle element 5 for magnetic attachment of the finial 4 to the end 2e of the curtain rod 2 (e.g. the push plug element 8 can be pre-attached to finial fastener 4a, the push plug element 8 can be a portion of the finial 4 for projecting from the finial 4 for insertion into the receptacle element 5, etc). In embodiments that utilize a magnetic element 9, the magnetic element 9 can be positioned in the push plug element 8 that is included in the finial 4 for such an embodiment.

The combination of the positioning of the magnetic member 7 within the channel 5c of the receptacle element 5, length and position of the magnetic element 9, and size and shape of the push plug element 8 and its channel 8c can accommodate a relatively wide range of finial configurations that may have shorter or longer fasteners 4a. Also, the magnetic field provided via the magnetic member 7 (as may be adjusted or affected by the magnetic element 9 when used) can permit the finial 4 to be attached by hand without use of any mechanical tools. For example, the finial 4 can be retained via the magnetic attraction between the magnetic member 7 and the finial 4. In some configurations, the fastener element 4a can be rotated via rotation of the finial 4 to tighten the finial into attachment with the push plug element 8 via mating threads of the channel 8c and threads of the finial fastener 4a. In other configurations, no such engagement may be needed and the magnetic attraction alone may be sufficient to retain the finial 4 for attachment of the finial 4 to the end 2e of the curtain rod 2. The finial 4 may not need to have a fastener 4a or may simply have its fastener 4a positioned within the channel 8c of the push plug element 8 for attachment of the finial 4 to the end 2e of the curtain rod 2.

Securing of the finial 4 to the end 2e of the curtain rod 2 can also be facilitated via a collar 4c defined at a proximal end of the finial 4 for being positioned around and cover a distal end portion of end 2e of the curtain rod. The collar 4c can help the finial 4 be securely attached via the magnetic attraction between the magnetic member 7 and other magnetic elements without being unintentionally removed via gravity. An annular gap 4g can be defined in the proximal end of the finial 4. The annular gap can be ring shaped or have another type of shape that is sized to receive the distal annular edge of the end 2e of the curtain rod 2 therein so the collar 4c can be securely positioned over the end 2e of the curtain rod and contact the outer periphery of the end 2e adjacent its annular edge to encircle the outer end 2e and help secure the finial 4 to the curtain rod 2 via its magnetic attachment, for example.

Once attached, the finial 4 can be easily removed as well. For example, in embodiments where the finial fastener 4a is in tight engagement with the push plug element 8, the finial 4 can be rotated to remove the finial 4 and replace it with another replacement finial 4. In situations where there is no tight engagement between a finial fastener 4a and the push plug element 8, a user can just apply a force on the finial 4 via his or her hand to move the finial 4 away from the curtain rod 2 to overcome the magnetic force applied via the magnetic member 7 and/or magnetic element 9 for releasing the finial 4 from the curtain rod 2 to remove the finial 4 from the curtain rod 2 without any mechanical tools. The removed finial 4 can be separated from the curtain rod 2 so that the finial 4 can be replaced with another more desired finial 4, for example.

In situations where a finial is rotated for engagement with the push plug element 8 to supplement the magnetic attachment that can be provided via the magnetic member 7, rotation of the finial 4 in a first rotational direction (e.g. clockwise or counterclockwise) can tighten the finial 4 into attachment with the curtain rod's end 2e and rotation in the opposite rotational direction can loosen the finial 4 for removal of the finial 4. No mechanical tool may be needed for such attachment and removal.

Further, a tool may not be needed for positioning of the finial attachment mechanism 10 within the end 2e of the curtain rod 2. For instance, the curtain rod 2 can have the finial attachment mechanism 10 positioned therein during manufacture or a user can position the receptacle element 5, magnetic member 7, push plug element 8 and magnetic element 9 (when needed or used) in the end 2e of the curtain rod 2 before attaching the finial 4 to that end of the curtain rod.

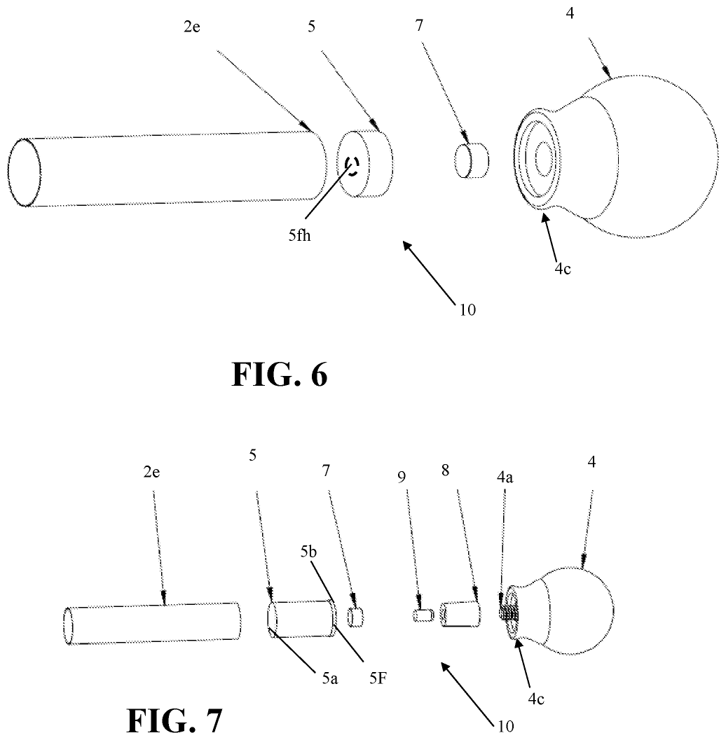

Referring to FIG. 6, another embodiment of the finial attachment mechanism 10 is shown that utilizes a receptacle element 5 that is configured for positioning within the end 2e of the curtain rod for retention of a magnetic member 7 between the receptacle element 5 and an inner end of the finial 4. The finial 4 and the receptacle element 5 can include magnetic material or a ferromagnetic material so that the magnetic member's magnetic field can attract and connect the finial 4 to the receptacle element 5 via the magnetic member 7 and the magnetic attraction between the magnetic member 7 and the finial 4. The receptacle element can also have a hole 5fh for receipt of a fastener or bolt in the event the finial 4 includes such fastener or other projection. The use of the projection or fastener extending from the finial 4 for insertion into the hole 5fh can help locate the finial for attachment more easily, allow the finial to be easily centrally positioned at an end 2e of the curtain rod 2 and/or permit the finial to be sufficiently located at an end 2e so that a proximal end collar 4c of the finial 4 can encircle the peripheral edge of the end 2e to help secure the finial on the end 2e in conjunction with the magnetic attraction between the magnetic member 7 and receptacle element 5 to provide a secure releasable attachment that can prevent the finial 4 from unintentionally falling off of the end 2e due to gravity.

In the embodiment of FIG. 6, a user's hand can be positioned on the finial 4 for exerting a force to overcome the magnetic attraction for removal of the finial 4 from the end 2e of the curtain rod 2. The user can also use his or her hand to position the finial 4 at an end 2e of the curtain rod 2 for attachment to the end 2e via the magnetic attraction between the finial 4 and the magnetic member 7 within the receptacle element 5 positioned in the end 2e of the curtain rod 2.

Referring to FIG. 7, another embodiment of the finial attachment mechanism 10 is illustrated. In the embodiment of FIG. 7, the receptacle element 5 may not include any legs 5L or slits 5s. The face 5F of the receptacle element can be configured to be in communication with channel 5c via an opening 50 defined in the face 5F for receipt of the magnetic member 7 and/or magnetic element 9 and push plug element 8 for magnetic attachment with the finial 4 so the finial 4 can be releasably attached to the end 2e of the curtain rod 2. The push plug element 8 can have a tapered shape or other shape for an interference fit connection within the receptacle element 5.

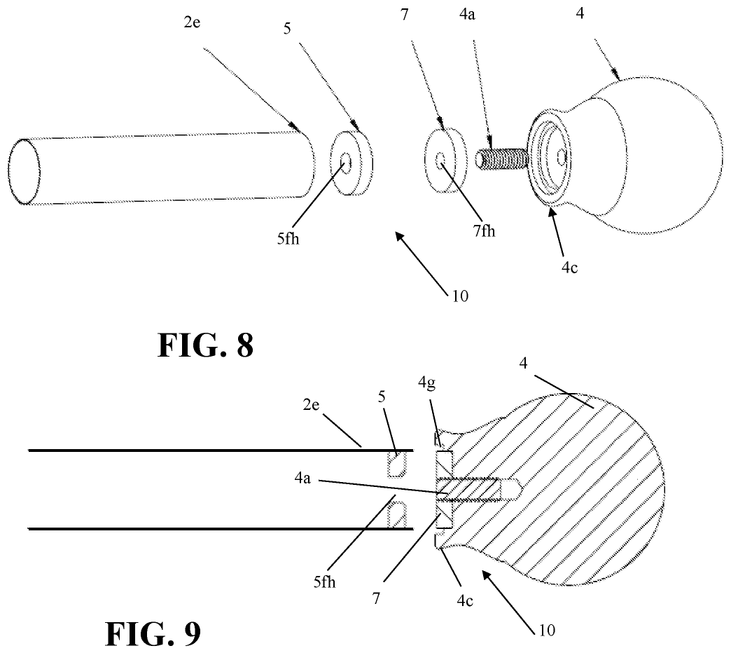

Referring to FIGS. 8 and 9, another embodiment of the finial attachment mechanism 10 can include a fastener 4a extending from the proximal end of the finial 4 for insertion into a hole 5fh of the receptacle element 5 positioned in the end 2e of the curtain rod. The hole 5fh of the receptacle element 5 can be alignable with a hole 7fh defined in a magnetic member 7 so that the fastener 4a can also be passed through the hole 7fh such that when the fastener 4a is passed through hole 5fh of the receptacle element 5 the magnetic member 7 can be positioned adjacent to the receptacle element 5 for magnetic attraction between the receptacle element 5 and the magnetic member 7 for magnetic attachment of the finial 4 to the end 2e of the curtain rod 2.

The fastener 4a can be a bolt or projection for being slid through the hole 5fh, for example, and can function as a locating element that helps centrally locate the finial 4 for magnetic attachment to the end 2e of the curtain rod 2. In such a configuration, the holes 5fh and 7fh of the receptacle element 5 and magnetic member 7 may not be threaded and the fastener 4a may not have threads or may not have threads that mate with threads of any of the holes 5fh and 7fh of the receptacle element 5 and the magnetic member 7.

For instance, the receptacle element 5 can include magnetic material or a ferromagnetic material so that the magnetic member's magnetic field can attract and connect the finial 4 to the receptacle element 5 via the magnetic member 7 and the magnetic attraction between the magnetic member 7 and the receptacle element 5. The finial 4 or fastener 4a can also include magnetic material or a ferromagnetic material so that the magnetic member's magnetic field can attract and connect the finial 4 to the receptacle element 5 via the magnetic member 7 and the magnetic attraction between the magnetic member 7 and the finial 4 or fastener 4a in addition to the magnetic attraction between the receptacle element 5 and the magnetic member 7.

As noted above, securing of the finial 4 to the end 2e of the curtain rod 2 can also be facilitated via a collar 4c defined at a proximal end of the finial 4 for being positioned around and cover a distal end portion of end 2e of the curtain rod. The collar 4c can help the finial 4 be securely attached via the magnetic attraction between the magnetic member 7 and other magnetic elements (e.g. receptacle element 5) without being unintentionally removed via gravity. An annular gap 4g can be defined in the proximal end of the finial 4 to receive the distal annular edge of the end 2e of the curtain rod 2 therein so the collar 4c can be securely positioned over the end 2e of the curtain rod and contact the outer periphery of the distal end 2e to encircle the outer end 2e and help secure the finial 4 to the curtain rod 2 via its magnetic attachment, for example.

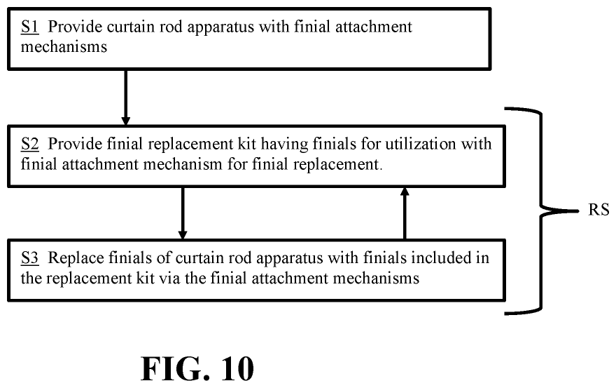

Embodiments of the curtain rod apparatus 1 and/or embodiments of the finial attachment mechanism 10 can be configured to permit implementation of an exemplary embodiment of a method for providing a curtain rod apparatus, which includes a first exemplary process RS for providing finial replacement kits or replacing finials 4. An example of such a method and an example of such processes are illustrated in FIG. 10.

In a first step S1, a curtain rod apparatus 1 can be provided. The curtain rod apparatus 1 can be provided with a finial attachment mechanism 10. Each end 2e of the curtain rod 2 of the curtain rod apparatus 1 can have a finial attachment mechanism provided therein, for example. In some embodiments, finial attachment mechanism assemblies can be provided for a user to position a finial attachment mechanism 10 in each end 2e of the curtain rod 2. Finials 4 can be attached to the ends 2e of the curtain rod via the finial attachment mechanisms 10. A use of a mechanical tool can be avoided when attaching the finials 4.

In a second step S2, at least one finial replacement kit can be provided. The replacement kit can include one or more replacement finials 4. The finials 4 attached to a curtain rod 2 can be removed and replaced with the replacement finials 4 of the replacement kit in a third step S3, for example. Such a removal of old finials 4 and attachment of the new replacement finials 4 can be provided via use of the finial attachment mechanisms 10 included in the ends 2e of the curtain rod 2.

The removal and replacement process RS can be repeated at different times to change the finials 4 attached to the curtain rod 2. Such finial adjustment can be provided to change an aesthetic effect of the curtain rod 2. For example, different seasonal themed finials can be used for different seasons (e.g. a fall or Halloween themed set of finials can be replaced with a Christmas themed set of finials, the Christmas themed finials can then be replaced with spring or Easter themed finials, etc.). As another example, the finials 4 can be replaced at different times to provide a different desired aesthetic effect (e.g. different sized, shaped, surface treatment, and/or material composition of the finial). As yet another example, finials 4 can be replaced so a college or sport team themed set of finials can be attached to a curtain rod 2 to replace other finials 4.

Embodiments of the finial attachment mechanism 10 can be provided to help make it easy for consumers to replace finials 4. Also, embodiments can be configured to permit curtain rods 2 to have a more uniform finial attachment configuration so that a wide variety of finial types or configurations can be utilized with curtain rods 2 of different configurations.

Embodiments can permit a user to more easily utilize finials, replace finials, and better adapt a mounted curtain rod to account for a user's change in preferences for home decoration. Also, embodiments can permit a manufacturer to more easily configure curtain rods for finial attachment. Embodiments that can permit finial attachment without use of a mechanical tool can also help permit consumers to more easily install finials 4 and replace them. For instance, embodiments can permit a user to more intuitively install finials 4 and/or replace them without reference to complicated instructions or use of tools as discussed above.

It should be understood that different embodiments of the curtain rod apparatus and finial attachment mechanism may include different elements to meet different sets of design criteria. For instance, the curtain rod apparatus can be configured for a single curtain or multiple curtains. As another example, the curtain rod of the curtain rod apparatus can utilize different types of mounting brackets or mounting devices for being mounted adjacent a window opening or door opening. As yet another example, the size and shape of various elements can be adjusted to account for a particulate type of size, dimension, or component structural property that may be desired to meet a particular set of design criteria. Thus, while certain exemplary embodiments of a curtain rod apparatus, a finial attachment mechanism, and methods of making and using the same have been shown and described above, it is to be distinctly understood that the invention is not limited thereto but may be otherwise variously embodied and practiced within the scope of the following claims.

What is claimed is:

1. A curtain rod apparatus comprising:
a curtain rod having a first end and a second end;
a plurality of finial attachment mechanisms including a first finial attachment mechanism and a second finial attachment mechanism;
the first finial attachment mechanism positionable in the first end of the curtain rod;
the second finial attachment mechanism positionable in the second end of the curtain rod;
each of the finial attachment mechanisms comprising:
a receptacle element positionable in the curtain rod; and
a magnetic member positionable in or adjacent the receptacle element.

2. The curtain rod apparatus of claim 1, wherein each of the finial attachment mechanisms also comprises:
a push plug element positionable within the receptacle element adjacent to the magnetic member.

3. The curtain rod apparatus of claim 2, wherein each of the finial attachment mechanisms also comprises:
a magnetic element positionable between the magnetic member and the push plug element.

4. The curtain rod apparatus of claim 3, wherein the magnetic element includes a pin comprised of a ferromagnetic material and/or comprises a magnet.

5. The curtain rod apparatus of claim 1, comprising:
a first finial removably attached to the first end of the curtain rod via the first finial attachment mechanism; and
a second finial removably attached to the second end of the curtain rod via the second finial attachment mechanism.

6. The curtain rod apparatus of claim 5, wherein the first finial is removably attached to the first end of the curtain rod via magnetic attraction with the magnetic member of the first finial attachment mechanism without use of any mechanical tool and the second finial is removably attached to the second end of the curtain rod via magnetic attraction with the magnetic member of the second finial attachment mechanism without use of any mechanical tool.

7. The curtain rod apparatus of claim 1, wherein the curtain rod is an adjustable length curtain rod.

8. The curtain rod apparatus of claim 1, wherein the curtain rod is configured to support curtain material hangable from the curtain rod.

9. The curtain rod apparatus of claim 1, comprising:
a first finial removably attached to the first end of the curtain rod via the first finial attachment mechanism, the first finial having a first collar defined in a proximal end of the first finial, the first collar having a gap that is sized to receive a portion of the first end of the curtain rod therein; and
a second finial removably attached to the second end of the curtain rod via the second finial attachment mechanism, the second finial having a second collar defined in a proximal end of the second finial, the second collar having a gap that is sized to receive a portion of the second end of the curtain rod therein.

10. A finial attachment mechanism for removably attaching a finial to an end of a curtain rod, the final attachment mechanism comprising:
a receptacle element positionable in the end of the curtain rod; and
a magnetic member positionable in or adjacent the receptacle element for magnetic attachment with the finial for removably attaching the finial to the end of the curtain rod.

11. The finial attachment mechanism of claim 10, wherein the receptacle element has at least one slit in communication with a channel, the magnetic member positioned within the channel of the receptacle element.

12. The finial attachment mechanism of claim 11, wherein the receptacle element has an inner end and an outer end, each of the at least one slit extending from the inner end to an intermediate portion of the receptacle element that is spaced apart from the outer end.

13. The finial attachment mechanism of claim 10, comprising:
a push plug element positionable within the receptacle element adjacent to the magnetic member.

14. The finial attachment mechanism of claim 13, comprising:
a magnetic element positionable between the magnetic member and the push plug element.

15. The finial attachment mechanism of claim 14, wherein the magnetic element includes a pin comprised of a ferromagnetic material and the magnetic member is a magnet.

16. The finial attachment mechanism of claim 15, wherein the receptacle element has at least one slit in communication with a channel, the magnetic member positioned within the channel of the receptacle element.

17. The finial attachment mechanism of claim 16, wherein the receptacle element has an inner end and an outer end, each of the at least one slit extending from the inner end to an intermediate portion of a body of the receptacle element that is between the inner end and the outer end.

18. The finial attachment mechanism of claim 17, wherein the removable attachment of the finial to the end of the curtain rod via the magnetic member is without use of a mechanical tool.

19. The finial attachment mechanism of claim 10, wherein the magnetic member has a hole that is alignable with a hole of the receptacle element, the hole of the magnetic member and the hole of the receptacle element sized to receive a fastener or projection extending from the finial.

20. A process for finial replacement comprising:
providing a finial replacement kit comprising replacement finials for attachment to a curtain rod, the replacement finials including a first replacement finial and a second replacement finial;
removing a first finial attached to a first end of the curtain rod without use of a mechanical tool via a first finial attachment mechanism of the first end of the curtain rod;
removing a second finial attached to a second end of the curtain rod without use of a mechanical tool via a second finial attachment mechanism of the second end of the curtain rod;
attaching the first replacement finial to the first end of the curtain rod without use of a mechanical tool via a magnetic attraction between a magnetic member of the first finial attachment mechanism and the first replacement finial; and
attaching the second replacement finial to the first end of the curtain rod without use of a mechanical tool via a magnetic attraction between a magnetic member of the second finial attachment mechanism and the second replacement finial.
